(19) United States
(12) Patent Application Publication
(10) Pub. No.: US 2018/0136829 A1
(43) Pub. Date: May 17, 2018

(54) CORRELATION OF TASKS, DOCUMENTS, AND COMMUNICATIONS

(71) Applicant: MICROSOFT TECHNOLOGY LICENSING, LLC, Redmond, WA (US)

(72) Inventors: Shahil Soni, Redmond, WA (US); Alexander W. Darrow, Bellevue, WA (US); Joseph Masterson, Bellevue, WA (US); Hayley Steplyk, Cambridge, MA (US)

(73) Assignee: MICROSOFT TECHNOLOGY LICENSING, LLC, Redmond, WA (US)

(21) Appl. No.: 15/348,989

(22) Filed: Nov. 11, 2016

(51) Int. Cl. G06F 3/0484; G06F 17/24; G06F 3/0481

(52) U.S. Cl. CPC G06F 3/04847; H04L 67/10; G06F 3/0481; G06F 17/24

(57) ABSTRACT

Correlation of tasks, documents, and communications is provided. In some examples, one or more tasks may be associated with a document when the document is generated, an existing document, or a document attached to a communication. The tasks may be presented to users through a user interface (UI) of an application associated with the document, a UI of the communication application providing the communication, or a separate task management application. Users may be allowed to track, close, or otherwise edit the tasks. Users may also create new tasks associated with a document that already has tasks associated with it. The tasks may be persisted with the document and alerts or reminders associated with one or more tasks across multiple documents may be provided to select users.

### BACKGROUND

A variety of tools allow users to manage their daily lives such as task management applications for setting and tracking tasks, calendar applications for scheduling and facilitating meetings, communication applications for facilitating communications over a number of modalities between users. In addition, people generate, view, edit, and collaborate on an increasingly large number of documents of different types such as word processing documents, presentations, spreadsheets, and so on.

While some aspects of these various tools are combined in umbrella services such as productivity services, there is still considerable room to improve the integration of such tools and provide users enhanced capabilities for management of their tasks and collaborations. For example, tasks are typically managed in a discrete manner from other applications such as communication or productivity applications, whereas many tasks are related to generated or existing documents and/or communications.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to correlation of tasks, documents, and communications. In some examples, a task associated with a document may be determined and provided along with the document to be displayed to a user. Upon receiving a task feedback from the user, the task may be updated based on the feedback. Next, the updated task and the document may be made available to be displayed through one or more applications, where the updated task is persisted with the document.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where a system to provide correlation of tasks, documents, and communications may be implemented;

FIG. 2 illustrates another example network environment where a system to provide correlation of tasks, documents, and communications may be implemented;

FIG. 3 illustrates an example configuration of a system for correlation of tasks, documents, and communications;

FIG. 4 illustrates an example flow for correlation of tasks, documents, and communications;

FIG. 5 illustrates example stages in providing correlation of tasks, documents, and communications;

FIG. 6 is a networked environment, where a system according to embodiments may be implemented;

FIG. 7 is a block diagram of an example general purpose computing device, which may be used to provide correlation of tasks, documents, and communications; and

FIG. 8 illustrates a logic flow diagram of a method to provide correlation of tasks, documents, and communications.

### DETAILED DESCRIPTION

As briefly described above, embodiments are directed to correlation of tasks, documents, and communications. In some examples, one or more tasks may be associated with a document when the document is generated, an existing document, or a document attached to a communication. The tasks may be presented to users through a user interface (UI) of an application associated with the document, a UI of the communication application providing the communication, or a separate task management application. Users may be allowed to track, close, or otherwise edit the tasks. Users may also create new tasks associated with a document that already has tasks associated with it. The tasks may be persisted with the document and alerts or reminders associated with one or more tasks across multiple documents may be provided to select users.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing correlation of tasks, documents, and communications. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

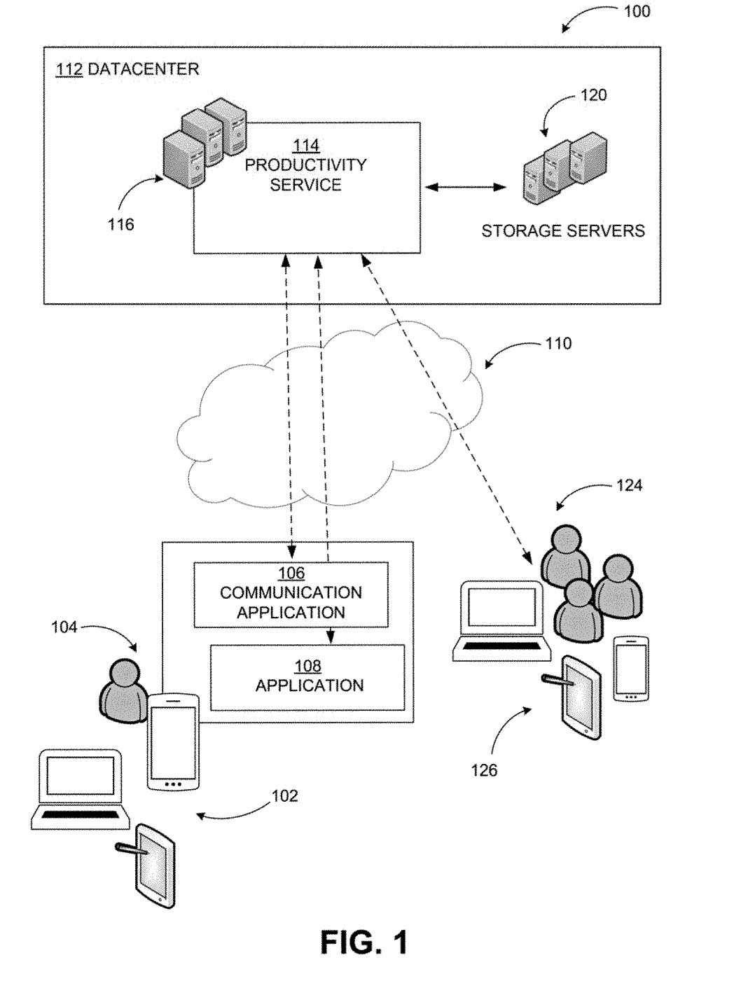

FIG. 1 includes an example network environment where a system to provide correlation of tasks, documents, and communications may be implemented.

As illustrated in diagram 100, an example system may include a datacenter 112 hosting a cloud-based productivity service 114 configured to provide communication, document processing, presentation, calendar management, and comparable services that may be accessed across multiple devices and users. The datacenter 112 may include one or more processing servers 116 configured to execute the productivity service 114, among other components. In some embodiments, at least one of the processing servers 116 may be operable to manage the productivity service 114, where data from devices (such as devices 102 and 126) may be stored at storage servers 120 (or associated data stores). As described herein, the productivity service 114 may be implemented as software, hardware, or combinations thereof.

In some embodiments, the productivity service 114 may be configured to interoperate with various applications to provide its services. For example, as illustrated in the diagram 100, a user 104 may execute a thin (e.g., a web browser) or a thick (e.g., a locally installed client application) version of a communication application 106 through the device 102 with which the productivity service 114 may be configured to integrate and intemperate with over one or more networks, such as network 110. Similarly, application 108 may be an application to provide access to document processing, presentations, facilitate calendar management, or other tasks. The communication application 106 and the application 108 may be applications hosted by the communication service, such as communication clients, for example. The device 102 may include a desktop computer, a laptop computer, a tablet computer, a vehicle mount computer, a smart phone, or a wearable computing device, among other similar devices. A communication interface may facilitate communication between the productivity service 114 and the communication application 106 or application 108 over the network 110.

In an example embodiment, the productivity service 114 may include a task management module configured to perform task management far subscribers of the productivity service 114. Users may be allowed to generate tasks associated with a document through application 108, for example, when the document is generated, edited, or viewed. Tasks may also be generated through the communication application 106 when a document is attached to a communication. The tasks may be presented to users through a UI of the application 106 associated with the document, a UI of the communication application 108 providing the communication, or a separate task management application. Users may be allowed to track, close, or otherwise edit the tasks.

A system according to embodiments allows correlation of tasks, documents, and communications by associating tasks with individual documents and providing access to the tasks through the document, through a communication that includes the document, or through a separate task management application. By allowing correlation of tasks, documents, and communications, increased collaboration and efficiency, reduced local and cloud computing resource usage, reduced bandwidth usage, and increased security may be achieved.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of devices and users managing tasks associated with documents.

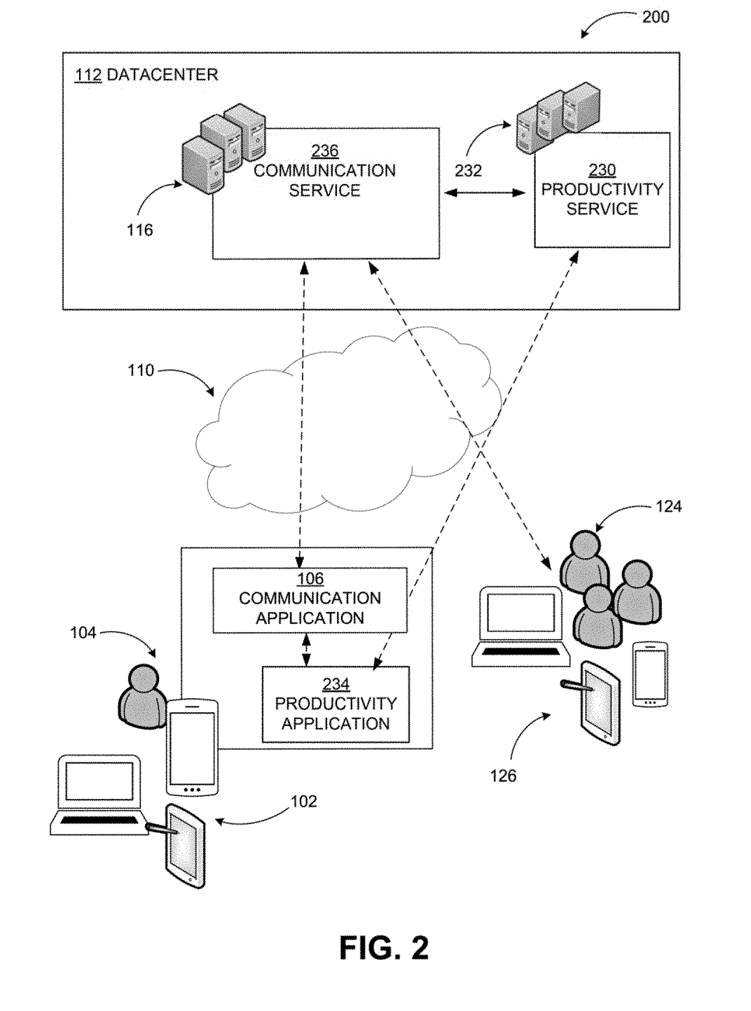

FIG. 2 illustrates another example network environment where a system to provide correlation of tasks, documents, and communications may be implemented.

Diagram 200 Shows a different configuration for providing correlation of tasks, documents, and communications. Elements of diagram 200 numbered similarly to the elements of diagram 100 may have similar attributes and perform similar actions as described in conjunction with FIG. 1. In the example configuration of diagram 200, the communication service 236 may interact with a productivity service 230 executed on one or more servers 232. Thus, upon detecting attachment of a document to a communication from a subscriber of the communication service 236 such as user 104, the productivity service 230 may receive or generate tasks as described above.

In some examples, the user 104 may generate tasks through a UI of the productivity application 234 or through the communication application 106. For example, the user 104 may type a task list into a communication, to which the document is attached, and associated the list with the document. Suitable control elements such as one to associate typed tasks with the document, one prompting the user to enter tasks, etc. may be provided on the respective UIs. The document may then be stored in a shared storage or sent to other users 124 in the communication.

The other users 124 may be allowed to see, edit, close, and otherwise process the tasks as the view or edit the document. The other users 124 may also be allowed to generate additional tasks. The tasks may be persisted with the document, for example in the document metadata or as a separate file that is associated with the document. Alerts or reminders associated with the tasks across multiple documents may be provided to all or some of the involved users.

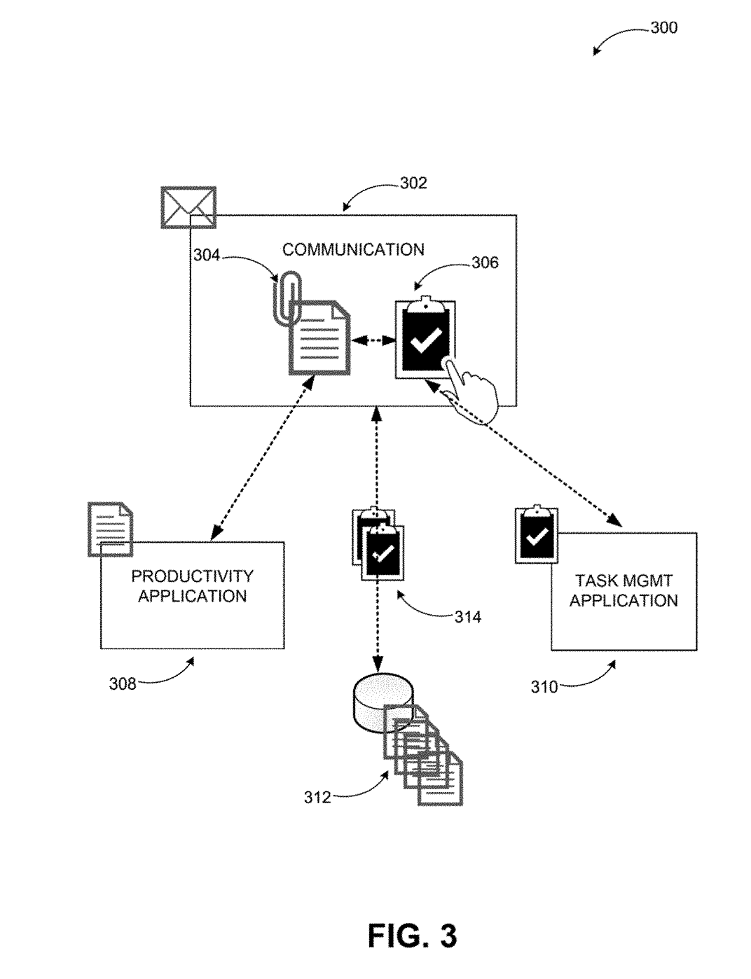

FIG. 3 illustrates an example configuration of a system for correlation of tasks, documents, and communications.

Diagram 300 shows conceptually an example configuration, where a document 304 may be included as attachment in a communication 302, for example, an email. The communication may also be a text message, an online meeting exchange, a meeting invite, and similar ones. A productivity application 308 may be a native application for the document 304 and allow creation, editing, viewing, and collaboration on the document. In some embodiments, one or more tasks 306 may be generated through the productivity application 308 and included in the communication 302 or generated through the communication 302. For example, a user may be prompted to enter the tasks 306 upon attaching the document to the communication. In other examples, the tasks 306 may be generated automatically by inference upon analyzing the document and the communication, for example, a recipient line, a subject line, and a body of the communication.

The tasks 306 may be persisted with the document 304, that is, they may be stored in metadata of the document 304 or stored in a file that is associated with the document 304. The tasks 306 may be managed by the productivity application 308, a communication application managing the communication 302, or task management application 310. Users may be allowed to provide feedback associated with the tasks such as editing the tasks, closing the tasks, creating new tasks, etc. through user interfaces provided by the productivity application 308, the communication application or the task management application 310. The original and updated tasks based on the received feedback may be stored as tasks 314 in a data store along with the documents 312.

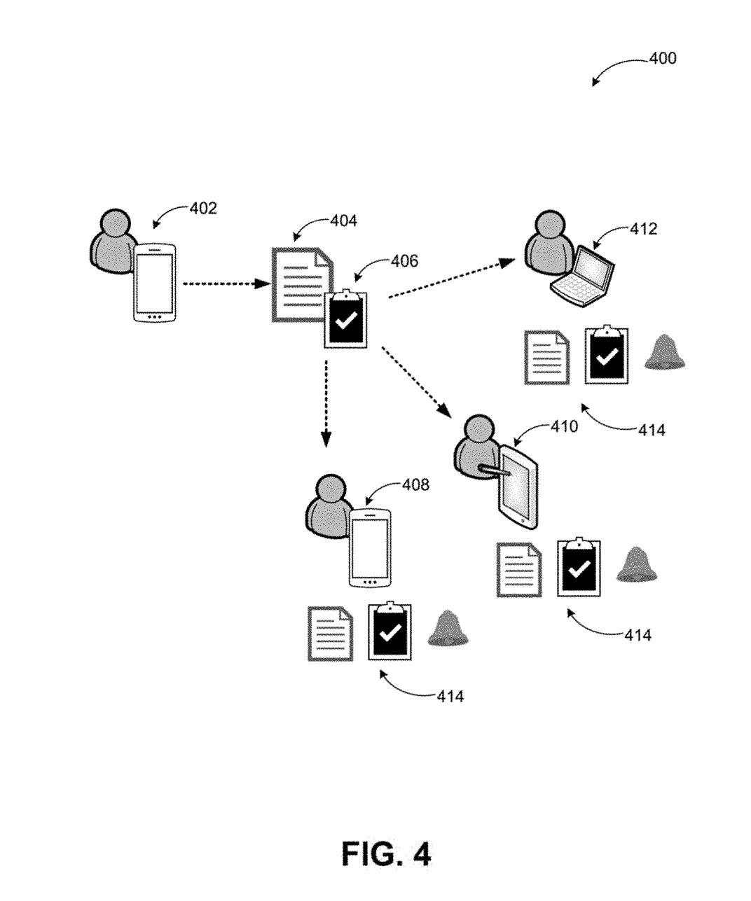

FIG. 4 illustrates an example flow for correlation of tasks, documents, and communications.

Diagram 400 shows conceptually creation of a task 406 in conjunction with a document 404 by a user 402. The user may create the task at the time of creating the document, while editing or viewing the document, or collaborating on a shared document with other users. The user 402 may also create the task 406 when attaching the document 404 to a communication. In any of the cases, the task 406 may be tied to the document 404 such that other users 408, 410, and 412 may have access to the task when the document is shared with them.

The user 402 may send the document 404 and the associated task 406 to the other users 408, 410, and 412 via email, text messaging, online conference, meeting invite, or other means, for example. Through the collaboration (sharing), the other users 408, 410, and 412 may not only receive the document to view, edit, and/or share with others, but also receive the associated task (414) to view, close, edit, etc.

Users collaborating on or sharing the document 404 may also receive reminders or alerts associated with the task 406 or other tasks associated with the document. Tasks and reminder may be disseminated through the communication that includes the document, through a separate communication, a task management application UI, or other means.

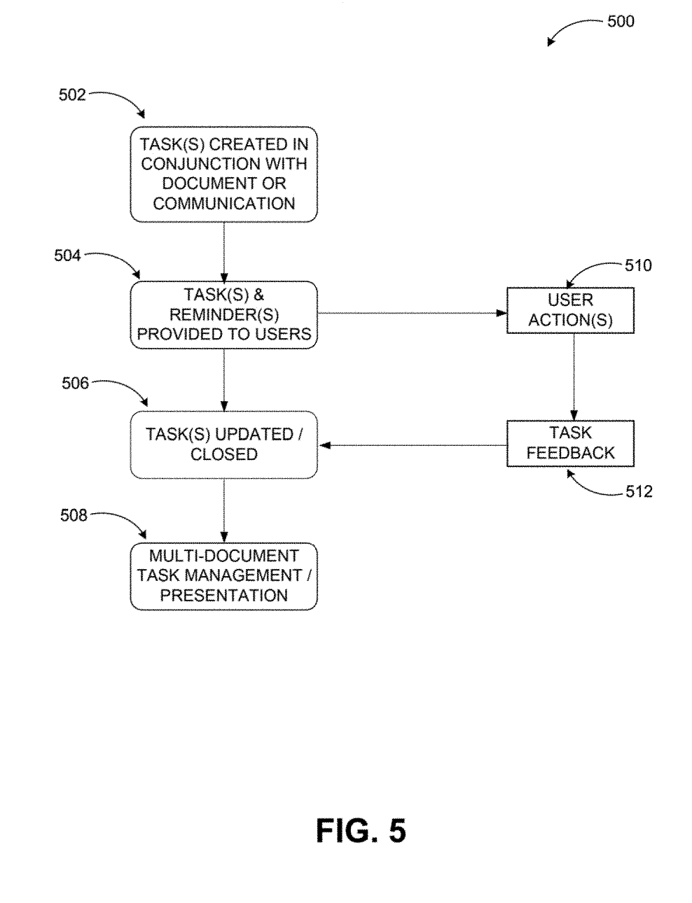

FIG. 5 illustrates example stages in providing correlation of tasks, documents, and communications.

As shown in diagram 500, tasks may be created (502) in conjunction with a document or a communication that includes the document through prompting a user or inference. The tasks and/or reminders for the tasks may be provided (504) to users that have access to the document or are indicated as recipients of the tasks. The users may perform actions (510) associated with the tasks such as closing the tasks, creating new tasks, editing existing tasks, etc. The user actions on the tasks may be provided as task feedback (512) to the system, which may close, update, or create new tasks (506) based on the feedback.

In some embodiments, multiple tasks associated with multiple documents may be managed (508) such that the tasks are available along with the documents through native document application UIs, through communication application UIs, or through task management application UIs. Reminders or alerts associated with the tasks may also be provide to the users depending on the due dates or periodically.

The examples provided in FIGS. 1 through 5 are illustrated with specific systems, services, applications, modules, codes, and notifications. Embodiments are not limited to environments according to these examples. Correlation of tasks, documents, and communications may be implemented in environ eats employing fewer or additional systems, services, applications, engines, codes, and user experience configurations. Furthermore, the example systems, services, applications, modules, and notifications shown in FIG. 1 through 5 may be implemented in a similar manner with other values using the principles described. herein.

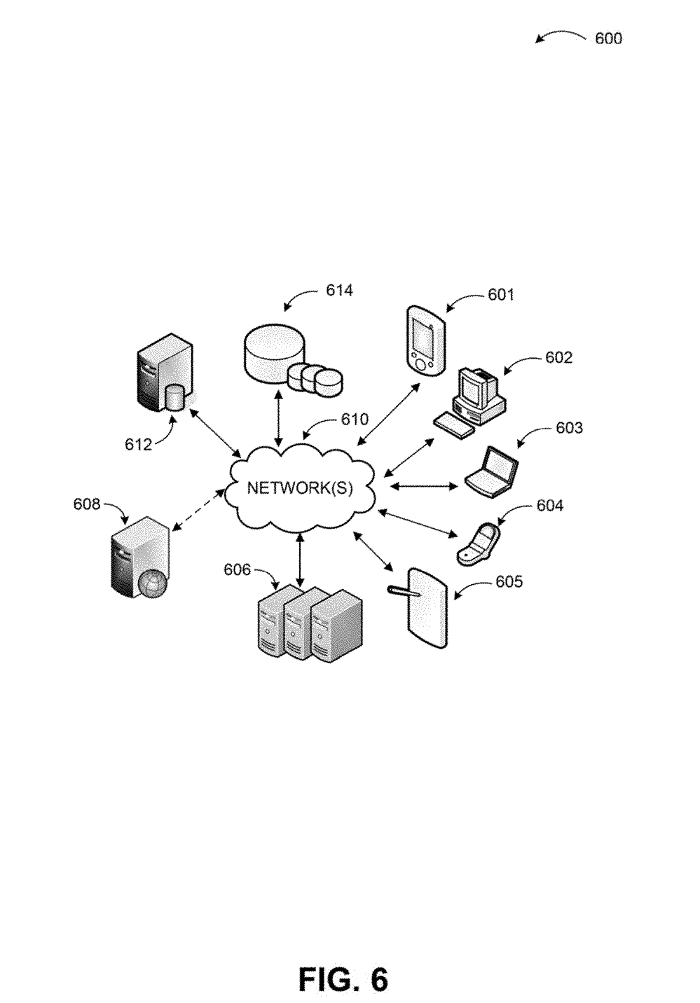

FIG. 6 is a networked environment, where a system according to embodiments may be implemented. In addition to locally installed applications (for example, application 106), correlation of tasks, documents, and communications may also be employed in conjunction with hosted applications and services (for example, a communication service 114) that may be implemented via software executed over one or more servers 606, individual server 608, or at client devices, as illustrated in diagram 600. A hosted service or application may communicate with client applications on individual computing devices such as a handheld computer 601, a desktop computer 602, a laptop computer 603, a smart phone 604, a tablet computer (or slate), 605 (‘client devices’) through network(s) 610 and control a user interface presented to users.

Client devices 601-605 are used to access the functionality provided by the hosted service or application. One or more of the servers 606 or server 608 may be used to provide a variety of services as discussed above. Relevant data such as task data, and similar may be stored in one or more data stores (e.g. data store 614), which may be managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, art unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed for correlation of tasks, documents, and communications. Furthermore, the networked environments discussed in FIG. 6 are for illustration purposes only. Embodiments are not limited to the example applications, engines, or processes.

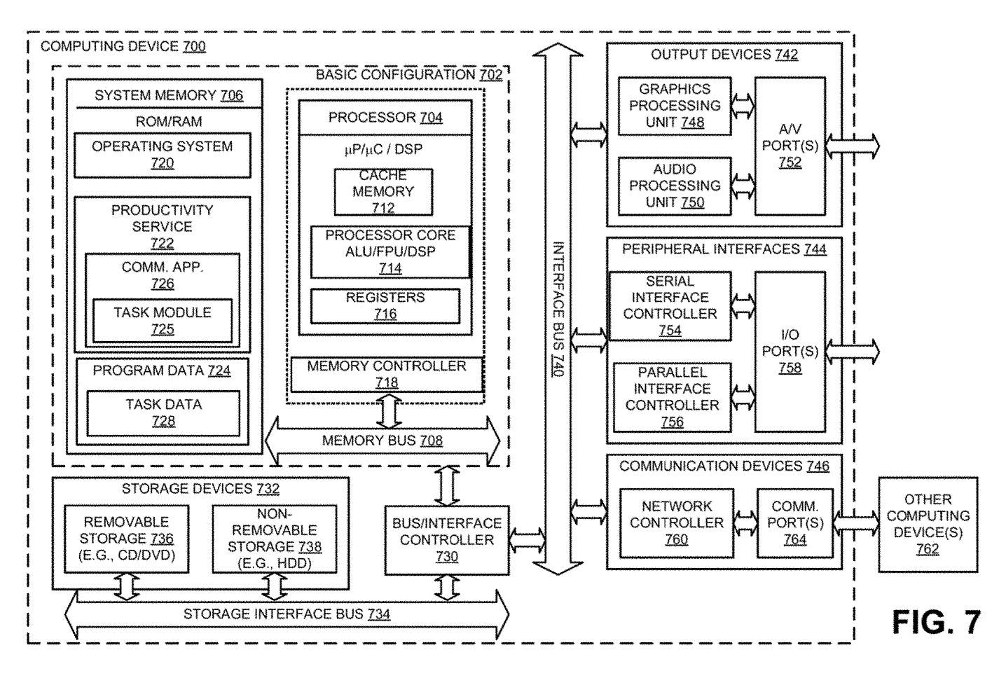

FIG. 7 is a block diagram of an example general purpose computing device, which may be used to provide correlation of tasks, documents, and communications.

For example, computing device 700 may be cased as a server, desktop computer, portable computer, smart phone, special purpose computer, or similar device. In an example basic configuration 702, the computing device 700 may include one or more processors 704 and a system memory 706. A memory bus 708 may be used for communicating between the process 704 and the system memory 706. The basic configuration 702 is illustrated in FIG. 7 by those components within the inn dashed line.

Depending on the desired configuration, the processor 704 may be of any type, including but not limited to a microprocessor (μP), a microcontroller (μC), a digital signal processor (DSP), or arty combination thereof. The processor 704 may include one more levels of caching, such as a level cache memory 712, one or more processor cores 714, and registers 716. The example processor cores 714 may (each) include an arithmetic logic unit (ALC), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a productivity service 722, a communication application 726 a task iodide 725, and program data 724. The task module 725 may determine tasks associated with a document, for example, attached to a communication, and facilitate dissemination, persistence, and management of the tasks across different devices and applications. The program data 724 may include, among other data, task data 728, as described herein.

The computing device 700 may have additional features or functionality, and additional interfaces to facilitate communications between the basic configuration 702 and any desired devices and interfaces. For example, a bus/interface controller 730 ma be used to facilitate communications between the basic configuration 702 and one or more data storage devices 732 via a storage interface bus 734. The data storage devices 732 may be one or more removable storage devices 736, one or more non-removable storage devices 738, or a combination thereof Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices for example, printer, scanner, etc.) via one or more I/O ports 758. An example communication device 746 includes a network controller 760, which may be arranged to facilitate communications with one or more other computing devices 762 over a network communication link via one or more communication ports 764. The me or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide correlation of tasks, documents, and communications. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

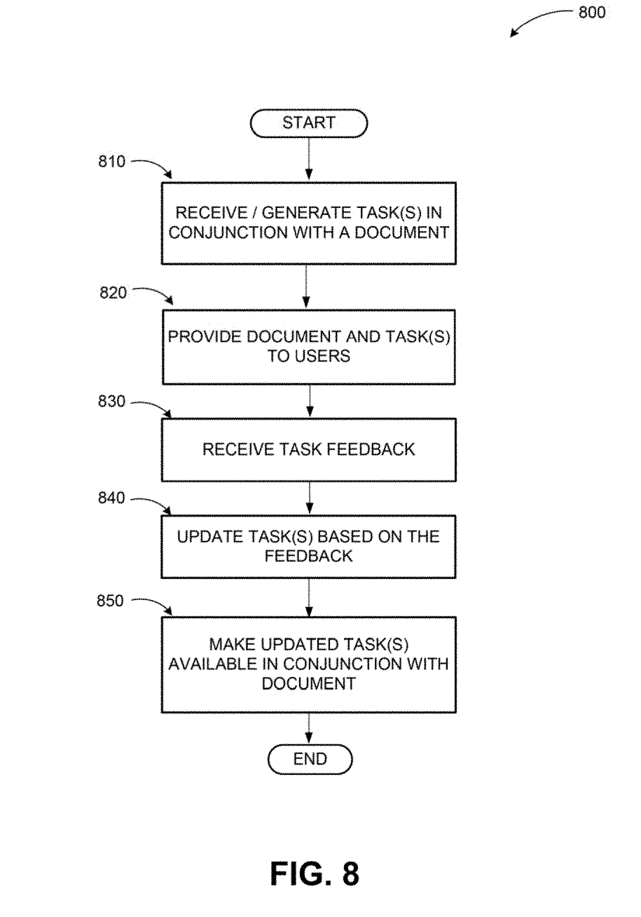

FIG. 8 illustrates a logic flow diagram of a method to provide correlation of tasks, documents, and communications.

Process 800 may be implemented on a computing device, server, or other system. An example system may include a computer communicatively coupled to a cloud server hosting a productivity or a task management service.

Process 800 begins with operation 810, where a task may be received or generated in conjunction with a document. The task may be received as input from a user or automatically generated based on inference. For example, a user may send a document in an email with a subject line that indicates the document needs to be reviewed by a certain date. The system may, thus, generate review tasks for the recipients of the email at the indicated date.

At operation 820, the document and associated tasks may be provided to relevant users through a communication, a shared storage, or other means. The users may be allowed to view, edit, check, close, and otherwise process the tasks. User actions on the tasks may be received as task feedback at operation 830. The tasks persisted with the associated document may be updated based on the feedback at operation 840. The updates may include dosing of some tasks, addition of new tasks, change of other tasks, etc.

At operation 850, the updated tasks may be made available in conjunction with the document. The users may be allowed to access the tasks (to view, edit, etc.) through a UI of a communication application, through a UI of a native document application, through a UI of a task management application, or similar ones.

The operations included in process 800 are for illustration purposes. Correlation of tasks, documents, and communications may be implemented by similar processes with fewer or additional steps, as well as in different order of operations using the principles described herein. Tice operations described herein may be executed by one or more processors operated on one or more computing devices, one or more processor cores, specialized processing devices, and/or general purpose processors, among other examples.

According to examples, a means for providing correlation of tasks, documents, and communications is described. The means may include a means for determining a task associated with a document; a means for providing the task and the document to be displayed to a user; a means for receiving a task feedback from the user; updating the task based on the feedback; and a means for availing the updated task and the document to be displayed through one or more applications, where the updated task is persisted with the document.

According to some examples, a method to provide correlation of tasks, documents, and communications is described. The method may include determining a task associated with a document; providing the task and the document to be displayed to user; receiving a task feedback from the user; updating the task based on the feedback; and availing the updated task and the document to be displayed through one or more applications, where the updated task is persisted with the document.

According to other examples, determining the task associated with the document may include receiving the task as input through a user interface (UI) of one of a processing application associated with the document, a communication application, and a task management application. Receiving the task as input through the UI of the communication application may include receiving the task through a communication to which the document is attached. Determining the task associated with the document may also include generating the task based on an inference made using content of a communication to which the document is attached. The method may further include analyzing one or more of a recipient list, a subject line, and a content of the communication to which the document is attached to.

According to further examples, the method may also include providing a first UI to display and receive feedback associated with the task in conjunction with a second UI to display the document. The document may be attached to a communication and the method may further include providing a third UI to display the communication. The method may also include providing a reminder associated with the task to the user through one or more of a communication application and a task management application. The document may be a word processing document, a spreadsheet document, a presentation document, a communication, a notebook document, a graphics document, or a project document.

According to other examples, a computing device to provide correlation of tasks, documents, and communications is described. The computing device may include a communication interface configured to facilitate communication between the computing device and one or more servers; a memory configured to store instructions; and one or more processors coupled to the memory, where the one or more processors, in conjunction with the instructions stored in the memory, are configured to execute components of a communication service. The components of the communication service may include an application configured to provide processing capability associated with a document; a communication application configured to facilitate exchange of communications between users; and a task management module. The task management module may be configured to receive a communication to which the document is attached; provide a user interface (UI) prompting a user to input one or more tasks associated with the document; receive the one or more tasks through the UI; provide the one or more tasks to a recipient of the communication; and update the one or more tasks based on feedback received from the recipient of the communication.

According to some examples, the task management module may be further configured to analyze one or more of a recipient list, a subject line, and a content of the communication to which the document is attached to; and infer the task from the analysis. The communication application may be further configured to display the document, the communication, and the one or more tasks in one or more UIs concurrently. The task management module may be further configured to provide one or more reminders associated with a plurality of tasks associated with a plurality of documents to one or more users. The one or more tasks may be received through a body of the communication. The communication may be an email, a text message, an online meeting exchange, or a meeting, invite.

According to further examples, a system to provide correlation of tasks, documents, and communications may be described. The system may include a first server configured to execute a productivity service; a second server configured to execute a communication service; and a third server configured to execute a task management service. The task management service may be configured to determine a task through one of receiving and generating based on inference, where the task is associated with a document managed by the productivity service; provide the task to be displayed through a user interface (UI) of one or more of a productivity service application, a communication service application, and a task management service application; receive a feedback associated with the task; and update the task based on the feedback, where the task is persisted with the document.

According to yet other examples, the task may be persisted in metadata of the document. The task may also be persisted in a file that is associated with the document. The task management service may be further configured to enable a user to one of edit the task, close the task, add a new task in conjunction with the document, and set a reminder for another user associated with the task. The task management application may be further configured to provide a UI to prompt users to input one or more tasks upon one of creation of the document, viewing of the document, editing of the document, and attachment of the document to a communication.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide correlation of tasks, documents, and communications, the method comprising:
determining a task associated with a document;
providing the task and the document to be displayed to a user;
receiving a task feedback from the user;
updating the task based on the feedback; and
availing the updated task and the document to be displayed through one or more applications, wherein the updated task is persisted with the document.

2. The method of claim 1, wherein determining the task associated with the document comprises:
receiving the task as input through a user interface (UI) of one of a processing application associated with the document, a communication application, and a task management application.

3. The method of claim 2, wherein receiving the task as input through the UI of the communication application comprises:
receiving the task through a communication to which the document is attached.

4. The method of claim 1, wherein determining the task associated with the document comprises:
generating the task based on an inference made using content of a communication to which the document is attached.

5. The method of claim 4, further comprising:
analyzing one or more of a recipient list, a subject line, and a content of the communication to which the document is attached to.

6. The method of claim 1, further comprising:
providing a first UI to display and receive feedback associated with the task in conjunction with a second UI to display the document.

7. The method of claim 6, wherein the document is attached to a communication and the method further comprises:
providing a third UI to display the communication.

8. The method of claim 1, further comprising:
providing a reminder associated with the task to the user through one or more of a communication application and a task management application.

9. The method of claim 1, wherein the document is one of a word processing document, a spreadsheet document, a presentation document, a communication, a notebook document, a graphics document, and a project document.

10. A computing device to provide correlation of tasks, documents, and communications, the computing device comprising:
a communication interface configured to facilitate communication between the computing device and one or more servers;
a memory configured to store instructions; and
one or more processors coupled to the memory, wherein the one or more processors, in conjunction with the instructions stored in the memory, are configured to execute components of a communication service, the components of the communication service comprising:
an application configured to provide processing capability associated with a document;
a communication application configured to facilitate exchange of communications between users; and
a task management module configured to:
receive a communication to which the document is attached;
provide a user interface (UI) prompting a user to input one or more tasks associated with the document;
receive the one or more tasks through the UI;
provide the one or more tasks to a recipient c f the communication; and
update the one or more tasks based on feedback received from the recipient of the communication.

11. The computing device of claim 10, wherein the task management module is further configured to:
analyze one or more of a recipient list, a subject line, and a content of the communication to which the document is attached to; and
infer the task from the analysis.

12. The computing device of claim 10, wherein the communication application is further configured to display the document, the communication, and the one or more tasks in one or more UIs concurrently.

13. The computing device of claim 10, wherein the task management module is further configured to provide one or more reminders associated with a plurality of tasks associated with a plurality of documents to one or more users.

14. The computing device of claim 10, wherein the one or more tasks are received through a body of the communication.

15. The computing device of claim 10, wherein the communication is one of an email, a text message, an online meeting exchange, and a meeting invite.

16. A system to provide correlation of tasks, documents, and communications, the system comprising:
a first server configured to execute a productivity service;
a second server configured to execute a communication service; and
a third server configured to execute a task management service, wherein the task management service is configured to:
determine a task through one of receiving and generating based on inference, wherein the task is associated with a document managed by the productivity service;
provide the task to be displayed through a user interface (UI) of one or more of a productivity service application, a communication service application, and a task management service application;
receive a feedback associated with the task; and
update the task based on the feedback, wherein the task is persisted with the document.

17. The system of claim 16, wherein the task is persisted in metadata of the document.

18. The system of claim 16, wherein the task is persisted in a file that is associated with the document.

19. The system of claim 16, wherein the task management service is further configured to enable a user to one of edit the task, close the task, add a new task in conjunction with the document, and set a reminder for another user associated with the task.

20. The system of claim 16, wherein the task management application is further configured to provide a UI to prompt users to input cine or more tasks upon one of creation of the document, viewing of the document, editing of the document, and attachment of the document to a communication.
